(19) United States
(12) Patent Application Publication
(10) Pub. No.: US 2017/0088010 A1
(43) Pub. Date: Mar. 30, 2017

(54) Ground-Preparation Appliance Device and Method for Operating a Ground-Preparation Appliance Device

(71) Applicant: Robert Bosch GmbH, Stuttgart (DE)

(72) Inventors: Philip Tonks, Stowmarket (GB); Dave Reynolds, Bury St. Edmunds (GB); Gavin Ben Armstrong, Tostock (GB)

(21) Appl. No.: 15/278,349

(22) Filed: Sep. 28, 2016

(30) Foreign Application Priority Data
Sep. 28, 2015 (DE) 10 2015 218 540.0

(51) Int. Cl. B60L 11/18; A01D 34/82; A01D 34/00

(52) U.S. Cl. CPC B60L 11/1874; A01D 34/006; A01D 34/82; A01D 2101/00

(57) ABSTRACT

A ground-preparation appliance device includes an energy storage unit, a movably drivable preparation unit, and a temperature control unit. The preparation unit is configured to generate an airflow. The temperature-control unit is configured to use the airflow to transmit heat at least one of to and from the energy-storage unit.

This application claims priority under 35 U.S.C. §119 to patent application no. DE 10 2015 218 540.0, filed on Sep. 28, 2015 in Germany, the disclosure of which is incorporated herein by reference in its entirety.

### BACKGROUND

A ground-preparation appliance, in particular configured as a lawn mower, which has at least a rechargeable battery and at least a rotatably drivable preparation tool, wherein an air flow that is generated by the preparation tool is used for collecting cuttings has already been proposed.

### SUMMARY

The disclosure proceeds from a ground-preparation appliance device having at least an energy-storage unit and having at least a movably drivable preparation unit.

It is proposed that the ground-preparation appliance device has a temperature-control unit which, in particular, in at least an operating state is provided for using an air flow that is generated by the preparation unit and advantageously emanates from the preparation unit for transmitting heat, preferably at least by means of convection, from the energy-storage unit, in particular to an environmental region, and/or to the energy-storage unit, in particular from an environmental region. A flow direction of the air flow herein is advantageously at least substantially directed from the preparation unit toward the energy-storage unit. “Provided” is to be understood in particular to mean specially conceived and/or equipped. An object to be provided for a specific function is in particular to be understood to mean that the object fulfills and/or executes this specific function in at least an application state and/or an operating state.

A “ground-preparation appliance device” in this context is to be understood to be in particular at least a part, in particular a substructure, of a ground-preparation appliance, in particular of an autonomous ground-preparation appliance. In particular, the ground-preparation appliance device may also comprise the entire ground-preparation appliance, in particular the entire autonomous ground-preparation appliance. A “ground-preparation appliance” in this context is to be understood in particular to be an appliance which in particular by means of the preparation unit is provided for preparing a ground and/or a subsoil, advantageously in a direct manner, and/or which is provided for preparing a ground-proximate region and/or for preparing in the vicinity of the ground. Particularly preferably, a ground-preparation appliance herein may be configured, for example, as a vacuum cleaner, a power sweeper, a cleaning machine, as an ice resurfacing machine, as a scarification machine, as an in particular hand-held lawn trimmer, and/or advantageously as a lawn mower. Furthermore in this context, an “autonomous ground-preparation appliance” is to be understood to be in particular an appliance which performs an operation at least in part in a self-acting manner, such as, in particular, commencing in a self-acting manner, terminating in a self-acting manner, and/or at least selects in a self-acting manner a parameter such as a route parameter and/or a reversal point, and/or advantageously moves in a self-acting manner at least for performing an operation, and/or moves autonomously in a predefined operating region. In particular, the ground-preparation appliance device herein may at least have an appliance housing which advantageously is configured as an external housing, at least a ground-preparation chamber which in particular is disposed on a lower side and/or on a side of the ground-preparation appliance that faces the ground, at least a drive unit which in particular comprises at least one internal-combustion engine and/or advantageously at least one electric motor, at least an electronics unit, and/or at least a controller unit.

Furthermore, an “energy-storage unit” is to be understood to be in particular a unit which in particular is provided for at least temporarily storing and/or generating electrical energy. The energy-storage unit is advantageously provided for supplying the ground-preparation appliance device and/or at least a component of the ground-preparation appliance device such as, for example, the drive unit, the electronics unit, and/or the controller unit, with energy. The energy-storage unit herein may at least in part, preferably at least to a major part, and particularly preferably entirely be configured as an arbitrary energy-storage unit such as, for example, as a gas tank, as a fuel cell, as a condenser, as a battery, and/or preferably as a rechargeable battery such as, for example, as a rechargeable nickel-cadmium battery, and/or as a rechargeable lithium-ion battery. The energy-storage unit herein is preferably configured as an energy-storage cell, in particular as a battery cell and/or as a rechargeable battery cell. The term “at least to a major part” herein is to be understood to mean, in particular, at least 55%, advantageously at least 65%, preferably at least 75%, particularly preferably at least 85%, and particularly advantageously at least 95%.

Furthermore, a “preparation unit” is to be understood to be in particular a unit which is provided in particular for preparing, in particular for preparing an area, advantageously for preparing a ground and/or preparing in the vicinity of a ground. In particular, the preparation unit herein is configured to be drivable in a linear and/or advantageously in a rotatable and/or rotating manner. Moreover, the preparation unit at least in an operating state is preferably provided to generate, in particular by means of moving, advantageously by means of rotating and/or of rotatingly moving at least one air flow, in particular the air flow already mentioned above, and in particular not by way of a blower, a fan, in particular a motor fan, a ventilator and/or a vacuum generator, or the like. The preparation unit herein preferably at least comprises one, advantageously precisely one, preparation tool, in particular a ground-preparation tool. The preparation tool herein may be configured as an arbitrary, in particular movable preparation tool that is advantageously drivable in a rotating manner, such as, for example as a brush, a cloth, a rag, a thread, a rope, a cutter, a cutting blade, and/or as a rotor blade. In particular, the preparation tool is different from a blower, a fan, in particular a motor fan, a ventilator, and/or a vacuum generator, or the like. Moreover, the preparation unit can at least comprise one, advantageously precisely one, preparation-tool receptacle which is in particular provided for receiving the preparation tool. Preferably, the preparation unit, in particular the preparation tool, and/or the preparation-tool receptacle, is/are at least in part, preferably at least to a major part, and particularly preferably entirely disposed in the ground-preparation chamber.

Moreover, a “temperature-control unit” is to be understood to be in particular an in particular active and/or advantageously passive unit which in particular has at least a thermal connection to the energy-storage unit and/or to the air flow that is in particular generated by the preparation unit and/or advantageously emanates from the latter, and is advantageously provided for influencing a temperature of the energy-storage unit. One object “influencing” another object in this context is to be understood to mean in particular that the further object in the absence of the object has and/or assumes another state, another quantity, and/or another temperature than in the presence of the object. Advantageously, the temperature-control unit, by means of the air flow that is generated in particular by the preparation unit and/or advantageously emanates from the latter, is provided for modifying, adapting a temperature of the energy-storage unit in particular to an advantageous operation, and/or for keeping said temperature in a predefined and/or predefinable temperature range. Particularly preferably, the temperature-control unit is provided for modifying and/or adapting the temperature of the energy-storage unit in such a manner that the temperature of the energy-storage unit in particular at least during operation lies in an optimal operating-temperature range, in particular between 5° C. and 65° C., preferably between 10° C. and 45° C., and particularly preferably between 15° C. and 30° C. Advantageously, the temperature-control unit herein is disposed at least in part and preferably at least to a major part in the air flow that is generated in particular by the preparation unit and/or advantageously emanates from the latter. Furthermore, the temperature-control unit is particularly preferably at least in part, preferably at least to a major part, and particularly preferably entirely disposed in a vicinity of the preparation unit and advantageously of the preparation tool. Additionally, the temperature-control unit is advantageously at least in part disposed outside the appliance housing. The temperature-control unit herein may comprise, for example, at least a fluid duct, advantageously an air duct, at least an air-guiding means which may advantageously be disposed in a vicinity of the preparation unit and/or be configured integrally with the preparation unit, at least a Peltier element, at least a thermal transmitter, advantageously a cooling element, and/or at least a receptacle in particular for the energy-storage unit. A “vicinity” is to be understood in particular as a spatial region which is formed by points which from a reference point and/or a reference component, in particular the preparation unit, lie at a distance that is less than half, preferably less than a third, preferably less than a quarter, and particularly preferably less than a sixth of a diameter and/or of a main extent of the ground-preparation chamber and/or of the preparation unit, and/or which from a reference point and/or a reference component, in particular the preparation unit, are each spaced apart by at most 20 cm, preferably by at most 10 cm, and particularly preferably by at most 5 cm. “Integral” in this context is to mean in particular connected in at least a materially integral manner. The materially integral connection may be established, for example, by way of an adhesive process, an insert-molding process, a welding process, a soldering/brazing process, and/or another process. However, integral is advantageously to be understood as being shaped in one piece. This one piece is preferably manufactured from a single blank, one mass, and/or one casting, such as by an extrusion method, for example, and/or by an injection-molding method. Moreover, an “active object” is to be understood to be in particular an object which is provided for being actively controlled and/or actuated. Furthermore, a “passive object” is to be understood to be in particular an object which is free of any potential for being actuated. An efficiency, in particular a preparation efficiency, a time efficiency, a component efficiency, an installation-space efficiency, a charging efficiency, and/or a cost efficiency may be improved, in particular, by way of a corresponding design embodiment of the ground-preparation appliance device. In particular, the energy-storage unit may advantageously be operated in an optimal temperature range, on account of which damages and/or output losses may be avoided, and/or service life and/or durability may be increased. Flexibility may moreover be increased, in particular since an operation that is at least largely independent from environmental conditions may be achieved. Also, a charging time may advantageously be reduced when an energy-storage unit which is configured as a rechargeable battery is used, in particular cooling intervals prior to and/or during a charging cycle may be dispensed with by virtue of a lower operating temperature of the energy-storage unit.

The temperature-control unit is preferably provided for at least cooling the energy-storage unit, on account of which overheating of the energy-storage unit in particular in the case of temperatures above 65° C. may advantageously be avoided. Moreover, in particular in the case of high environmental temperatures such as in midsummer, cooling intervals may advantageously be avoided, on account of which more rapid preparation and/or optimized, in particular output-optimized and/or energy-optimized operation is enabled. Alternatively or additionally, however, it is also conceivable that the temperature-control unit is additionally provided for heating the energy-storage unit, for example while using waste heat from the drive unit, in particular during operation in the case of low environmental temperatures such as in cold seasons and/or in indoor ice rinks, for example. Alternatively or additionally, it is moreover conceivable that cooling and/or heating is performed by means of a base station of the ground-preparation appliance, a standalone blower unit which is provided in particular for removing condensate, an in particular additional cooling unit, and/or an in particular additional heating unit. Cooling of the energy-storage unit herein is preferably performed at least at a temperature of the energy-storage unit above 65° C., advantageously above 55° C., and particularly advantageously above 45° C. Moreover, heating of the energy-storage unit is preferably performed at least at a temperature of the energy-storage unit below 5° C., advantageously below 7.5° C., and particularly advantageously below 10° C.

Furthermore, particularly simple, rapid, and/or efficient heat transmission may be achieved in particular when the temperature-control unit advantageously directly contacts and/or touches the energy-storage unit. In particular, the temperature-control unit and the energy-storage unit herein have at least a contact area, the latter advantageously being adapted to both the former.

It is moreover proposed that the temperature-control unit has at least an energy-storage receptacle which is provided for at least in part, preferably at least to a major part and particularly preferably entirely receiving the energy-storage unit and for at least in part, preferably at least to a major part, and particularly preferably entirely disposing the latter in a vicinity of the preparation unit and advantageously of the preparation tool. In particular, the energy-storage unit thus in at least an operating state is at least in part, preferably at least to a major part, and particularly preferably entirely disposed in a vicinity of the preparation unit and advantageously of the preparation tool. Advantageously, the energy-storage receptacle and/or the energy-storage unit is/are furthermore at least in part and preferably at least to a major part disposed in the air flow that is, in particular, generated by the preparation unit, and/or advantageously emanates from the latter. Moreover, the energy-storage receptacle is advantageously provided for closing off the energy-storage unit at least in a substantially fluid-tight manner. An object being provided for “closing off” a further object “at least in a substantially fluid-tight manner” in this context is understood to mean in particular that the object is provided for preventing and/or blocking an ingress of a fluid, advantageously of a liquid, in particular into the further object to at least a degree of 95%, preferably at least to 97%, and particularly preferably at least to 99%. An efficiency of the heat transmission may be improved in particular on account thereof.

In one design embodiment of the disclosure it is proposed that the ground-preparation appliance device has at least a ground-preparation chamber, in particular the ground-preparation chamber already mentioned above, in which the preparation unit and advantageously at least the preparation tool at least to a major part and preferably entirely, and the temperature-control unit at least in part, are disposed. In particular, the air flow that is generated in particular by the preparation unit, and/or advantageously emanates from the latter, in this case impacts the temperature-control unit, in particular a component of the temperature-control unit that contacts and/or touches the energy-storage unit advantageously in a direct manner, preferably a thermal transmitter of the temperature-control unit, directly, in particularly without deflection, and/or without guides, on account of which additional air ducts in particular may be dispensed with. Moreover, a component efficiency may advantageously be increased, and an efficiency of the heat transmission may be further improved.

Preferably, the energy-storage unit is at least in part disposed in the ground-preparation chamber, on account of which a design embodiment which in particular is almost neutral in terms of installation space may advantageously be achieved.

In one preferred design embodiment of the disclosure it is proposed that the ground-preparation appliance device has at least a ground-preparation chamber, in particular the ground-preparation chamber already mentioned above, which defines at least an opening which is provided in particular for infeeding and/or outfeeding at least a part of a preparation material, advantageously a cut product, which in particular is to be prepared and/or has been prepared, to the preparation unit and/or from the preparation unit, the temperature-control unit being at least in part disposed in a vicinity of the opening. On account thereof, simple integration in particular may be achieved, in particular without having to perform extensive adaption work in terms of design. The opening herein corresponds in particular to a clearance of the ground-preparation chamber. Advantageously, the opening herein in relation to a preferred direction of movement of in particular the ground-preparation appliance is at least in part and preferably to at least a major part disposed ahead of or behind the preparation unit. Particularly preferably, the ground-preparation chamber at least has two, advantageously precisely two, openings, in particular one preparation-product infeed opening and one preparation-product outfeed opening.

The temperature-control unit could contact and/or touch the ground-preparation chamber directly, for example. However, it is preferably proposed that the ground-preparation appliance device has at least a ground-preparation chamber, in particular the ground-preparation chamber already mentioned above, by way of which the temperature-control unit is at least in part integrally configured. Advantageously, the temperature-control unit herein contacts the ground-preparation chamber across a large area. An object being “at least in part integrally configured” with a further object in this context is to be understood in particular, to mean that at least a component of the object and/or the object is/are integrally connected and/or configured by way of at least a component of the further object and/or of the further object. Two objects being in “contact across a large area” is to be understood, in particular, to mean that a contact area between the objects corresponds to a proportion in terms of area at least of 20%, advantageously at least of 40%, preferably at least of 60%, and particularly preferably at least of 80% of a lateral face of at least one of the objects, said lateral face facing in particular the other object. On account thereof, a particularly efficient heat transfer in particular between the temperature-control unit and the ground-preparation chamber may, in particular, be achieved.

Preferably, the temperature-control unit in relation to a preferred direction of movement in particular of the ground-preparation appliance is disposed in a forward region of the appliance housing and advantageously at least ahead of a drive shaft of the ground-preparation appliance device. In one particularly preferred design embodiment of the disclosure it is proposed that the temperature-control unit in relation to a preferred direction of movement in particular of the ground-preparation appliance is at least in part and preferably to at least a major part or entirely disposed ahead of the preparation unit, in particular at least ahead of the preparation-tool receptacle, and advantageously ahead of the preparation tool. On account thereof, a contamination of the temperature-control unit, in particularly by a preparation product such as, for example, cut product, or the like, may, in particular, be avoided.

It is furthermore proposed that the temperature-control unit has at least a thermal transmitter which in particular in at least an operating state is at least in part disposed in the air flow that is generated in particular by the preparation unit and/or advantageously emanates from the latter, and is advantageously provided for an in particular direct heat transmission and/or heat exchange between the air flow and the energy-storage unit. Particularly preferably, the thermal transmitter herein comprises a plurality, such as, for example, at least two, at least three, at least four, and/or at least five rib elements, in particular fins and/or pins, which advantageously at least in part are arcuate, advantageously circular-arcuate and/or are disposed in particular along a main flow direction of the air flow that is generated in particular by the preparation unit and/or advantageously emanates from the latter. In particular, at least the thermal transmitter is at least in an operating state at least in part, preferably to at least a major part, and particularly preferably entirely disposed in a vicinity of the preparation unit. Moreover, the thermal transmitter is preferably at least in part, preferably to at least a major part, and particularly preferably entirely disposed outside the appliance housing, advantageously in the ground-preparation chamber. Preferably, the thermal transmitter herein is at least in part, preferably to at least a major part, and particularly preferably entirely composed of a material which has an in particularly increased heat conductivity of at least 0.3 W/mK, and advantageously of at least 0.5 W/mK. On account thereof, a heat transmission and/or a heat exchange, in particular, may be simplified and/or accelerated.

In one preferred design embodiment of the disclosure it is proposed that the temperature-control unit has at least a thermal transmitter, in particular the thermal transmitter already mentioned above, which at least in part, preferably to at least a major part, and particularly preferably entirely is composed of an electrically isolating material. Alternatively or additionally, the thermal transmitter at least in part, preferably at least to a major part, and particularly preferably entirely, is composed of a corrosion-resistant material. The thermal transmitter particularly preferably at least in part, preferably at least to a major part, and particularly preferably entirely, is composed of a plastics, advantageously of an in particular synthetic polymer, preferably of HDPE (“high density polymer”), advantageously having a heat conductivity between 0.2 W/mK and 0.7 W/mK, and advantageously between 0.35 W/mK and 0.5 W/mK. On account thereof, costs in particular may be reduced and safety regulations may be met. Moreover, complex geometries and/or thermal transmitters having thin wall thicknesses may also be implemented, on account of which the temperature-control unit and in particular the thermal transmitter may advantageously be adapted to various conditions and/or circumstances. Moreover, a weight of the temperature-control unit may advantageously be kept low, on account of which an output efficiency may be increased, and/or a comfort in particular for a user may be improved.

In one design embodiment of the disclosure it is proposed that the energy-storage unit is configured to be interchangeable and/or replaceable. Advantageously, the temperature-control unit herein has at least an interface for coupling advantageously in a form-fitting manner in particular across a large area to the energy-storage unit, into which interface the energy-storage unit is interchangeably and/or replaceably introducible, advantageously in a plug-in manner such as by means of at least a sliding rail and at least one latching element, for example. Advantageously, the energy-storage unit herein has a further interface that in particular corresponds to the interface. Preferably, the temperature-control unit and the energy-storage unit herein bear on one another across a large area. Advantageously, a contact area between the temperature-control unit and the energy-storage unit herein is at least largely configured so as to be planar. Flexibility in particular may be advantageously improved on account thereof. Moreover, it is conceivable in this case, in particular in order to improve thermal contact, that the temperature-control unit has at least a contacting element such as, for example, a heat-conducting paste, a heat-conducting gel, and/or an elastic element having heat-conducting properties, which may advantageously be disposed in a vicinity of the interface, and/or between the interface and the energy-storage unit. It is conceivable herein, for example, that the contacting element, by means of compression when connecting the temperature-control unit to the energy-storage unit, configures a connection across a large area between the temperature-control unit and the energy-storage unit.

It is moreover proposed that the ground-preparation appliance device has at least one appliance housing, in particular the appliance housing already mentioned above, and at least one sealing unit which in particular is at least in part configured so as to be elastic, wherein the temperature-control unit is at least in part disposed outside the appliance housing, and the sealing unit is provided in order for a passage point of the temperature-control unit through the appliance housing to be closed off at least in a substantially fluid-tight manner. Advantageously, the sealing unit herein is at least in part, preferably at least to a major part, and particularly preferably entirely disposed between the temperature-control unit and the appliance housing, and particularly preferably directly contacts and/or touches the temperature-control unit and/or the appliance housing. Particularly preferably, the sealing unit at least in part, preferably to at least a major part, and particularly preferably entirely encompasses the temperature-control unit. The sealing unit herein may, in particular, at least in part, preferably at least to a major part, and particularly preferably entirely, be composed of an arbitrary material, but advantageously of an elastomer, a silicone, and/or a rubber. Particularly preferably, the sealing unit is at least provided in order to completely prevent the ingress of water into the appliance housing and/or into the temperature-control unit. On account thereof, advantageous sealing may, in particular, be achieved, and/or IP protection classifications may be met.

Furthermore, a ground-preparation appliance device having at least an energy-storage unit, and having at least a movably drivable preparation unit is proposed, wherein the ground-preparation appliance device has at least one appliance housing which is configured, in particular, as an external housing, and at least an insulating unit which is provided in order for the appliance housing to be at least in part, and preferably at least to a major part, insulated, in particular thermally insulated and/or acoustically insulated, in relation to an environment, in particular an environmental region of the ground-preparation appliance. An “insulating unit” in this case is to be understood to be in particular a unit which in particular is provided in order to at least in part influence, and advantageously to reduce, prevent and/or block at least in part a heat transfer, a heat proliferation, and/or a transmission of thermal energy, in particular through the appliance housing and/or into the appliance housing, and/or an acoustic transfer, an acoustic proliferation, and/or an acoustic transmission, in particular through the appliance housing. The insulating unit herein may at least in part, preferably at least to a major part, and particularly preferably entirely, be composed of an arbitrary material such as, for example, styrofoam, glass wool, rock wool, natural fibers, cellulose, perlite, and/or polystyrene. Moreover, the insulating unit may be present in an arbitrary form such as, for example, as a bulk material, as a mat, as a plate, as a foam, as a liquid, and/or as a gas. In particular, the insulating unit could also be configured by way of a vacuum unit which defines at least a region having a pressure, in particular an air pressure, of at most 300 mbar, advantageously of at most 100 mbar, and particularly advantageously of at most 1 mbar. In particular, the insulating unit is provided in order for at least the temperature-control unit and/or the energy-storage unit to be at least in part and preferably at least to a major part shielded. Furthermore, the insulating unit is in particular at least in part, preferably at least to a major part, and particularly preferably entirely, disposed in a vicinity of a housing shell of the appliance housing, and preferably in an upper region of the appliance housing in relation to an operating position of the ground-preparation appliance. Particularly advantageously, the insulating unit is disposed between an in particular solar-resistant external housing shell and an advantageously at least in part acoustically insulating internal housing shell. On account thereof, additional heating of the ground-preparation appliance device and/or of the ground-preparation appliance, in particular at least of the energy-storage unit, may, in particular, be reduced and/or advantageously be entirely avoided. Moreover, a sound level may advantageously be reduced, on account of which an operating comfort may in particular be increased.

Moreover, the disclosure proceeds from a method for operating a ground-preparation appliance device which comprises at least an energy-storage unit and at least a movably drivable preparation unit by way of which in at least an operating state at least one air flow that advantageously emanates from the preparation unit is generated.

It is proposed that the air flow, in particular in at least an operating state, is used for transmitting heat, preferably at least by means of convection, from the energy-storage unit in particular to an environmental region, and/or to the energy-storage unit in particular from an environmental region. On account thereof, an efficiency, in particular a preparation efficiency, a time efficiency, a component efficiency, an installation-space efficiency, and/or a cost efficiency may be improved in particular. Moreover, flexibility may be increased in particular since an operation that is at least largely independent of the environmental conditions may be achieved.

Herein, the ground-preparation appliance device is not to be limited to the application and embodiment described above. In particular, the ground-preparation appliance device in order to fulfill a functional mode which is described herein may have individual elements, components, and units which in terms of numbers deviate from any number mentioned herein.

### BRIEF DESCRIPTION OF THE DRAWINGS

Further advantages are derived from the following description of the drawing. An exemplary embodiment of the disclosure is illustrated in the drawing. The drawing, the description, and the claims contain numerous features in combination with one another. A person skilled in the art will expediently also view the features individually and combine the latter so as to form meaningful further combinations.

In the figures:

FIG. 1 shows a ground-preparation appliance, configured as an autonomous lawn mower, having a ground-preparation appliance device, in an illustration from above;

FIG. 2 shows the ground-preparation appliance in a lateral partial illustration;

FIG. 3 shows the ground-preparation appliance in an illustration from below;

FIG. 4 shows an energy-storage module of the ground-preparation appliance device, in a first exploded illustration from obliquely above;

FIG. 5 shows the energy-storage module in a second exploded illustration from obliquely below;

FIG. 6 shows the energy-storage module in an assembled state, in a view from below;

FIG. 7 shows a ground-preparation appliance having a further ground-preparation appliance device, in an illustration from below;

FIG. 8 shows a preparation unit of a further ground-preparation appliance device, in a perspective illustration;

FIG. 9 shows part of a preparation unit of a further ground-preparation appliance device, in a perspective illustration;

FIG. 10 shows the preparation unit of FIG. 9 in a perspective illustration; and

FIG. 11 shows a ground-preparation appliance having a further ground-preparation appliance device, in a perspective illustration.

### DETAILED DESCRIPTION

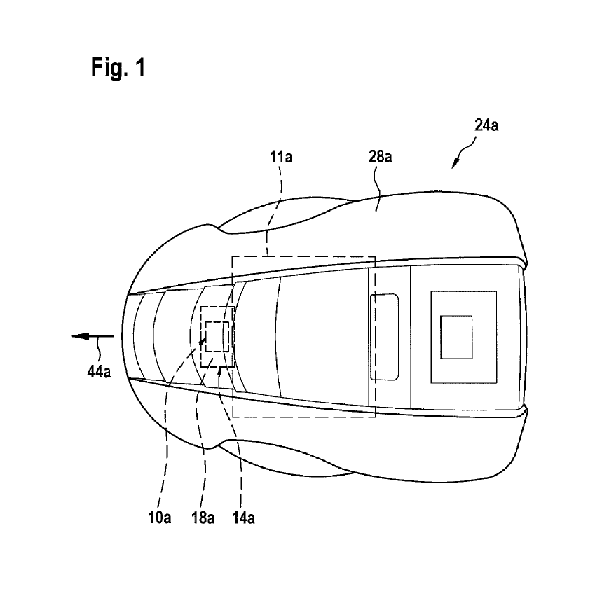

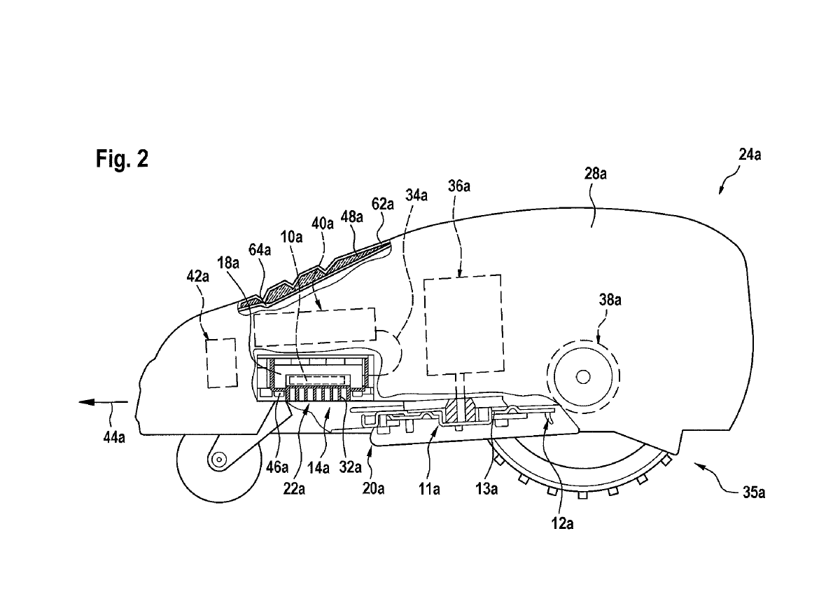

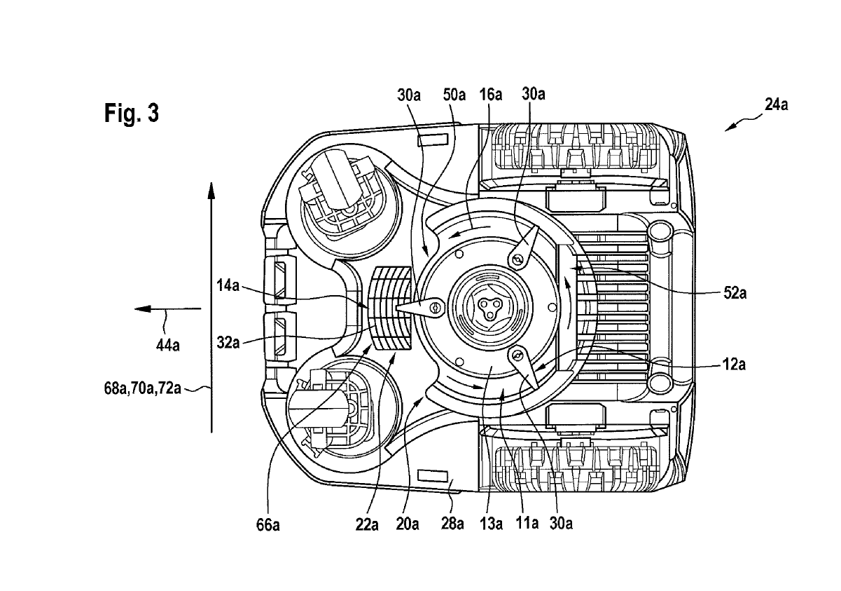

FIGS. 1 to 3 show a ground-preparation appliance 24a in an illustration from above (cf. FIG. 1), in a lateral partial illustration (cf. FIG. 2), and in an illustration from below (cf. FIG. 3), wherein for the sake of clarity some components of the ground-preparation appliance 24a have been removed in particular in FIG. 2. The ground-preparation appliance 24a in the present case is configured as an autonomous ground-preparation appliance. The ground-preparation appliance 24a is configured to be self-driving and is in particular provided for performing ground preparation in a self-acting manner. The ground-preparation appliance 24a is configured so as to be operated with a rechargeable battery. The ground-preparation appliance 24a herein in an exemplary manner is configured as an autonomous lawn mower and is provided in particular for preparing a ground-proximate region, in particular for cutting and/or mowing a lawned area. Alternatively, however, a ground-preparation appliance may also be configured as another ground-preparation appliance such as, for example, as a vacuum cleaner, a power sweeper, a cleaning machine, as an ice resurfacing machine, as a scarification machine, and/or as an in particular hand-held lawn trimmer.

The ground-preparation appliance 24a has a ground-preparation appliance device. The ground-preparation appliance device comprises an appliance housing 28a. The appliance housing 28a is configured as an external housing. At least a major part of the components necessary for operating the ground-preparation appliance 24a is disposed within the appliance housing 28a. In the present case, the appliance housing 28a at least in a part-region has an external housing shell 62a and an internal housing shell 64a. The external housing shell 62a faces an environment. The external housing shell 62a is configured so as to be solar-resistant. The internal housing shell 64a faces away from the environment. The internal housing shell 64a at least in part is configured so as to be acoustically insulating. The external housing shell 62a and the internal housing shell 64a define an insulating-unit receptacle region. Alternatively, however, it is also conceivable for an insulating-unit receptacle region and/or at least one of the housing shells to be dispensed with. Moreover, the ground-preparation appliance device has a running gear 35a which is known per se. Furthermore, the ground-preparation appliance device has a ground-preparation chamber 20a. The ground-preparation chamber 20a is disposed on a lower side and/or on a side of the ground-preparation appliance 24a that faces the ground. The ground-preparation chamber 20a herein is open toward the lower side and/or on that side of the ground-preparation appliance 24a that faces the ground. The ground-preparation chamber 20a in the present case is configured as a cutting bowl. The ground-preparation chamber 20a is composed of plastics. Alternatively, it is conceivable that a ground-preparation chamber at least in part, preferably to at least a major part, and particularly preferably entirely, is composed of any other material such as, for example, of a composite material, an alloy, a ceramics material, and/or a metal. The ground-preparation appliance device furthermore has a preparation unit 11a. The preparation unit 11a is at least in part disposed in the ground-preparation chamber 20a. The preparation unit 11a comprises a preparation-tool receptacle 13a. Moreover, the preparation unit 11a has a preparation tool 12a. The preparation tool 12a is configured so as to be rotatable and/or rotatingly drivable. The preparation tool 12a is configured as a cutter blade. The preparation tool 12a herein is different from a blower, a fan, in particular a motor fan, a ventilator, and/or a vacuum generator, or the like. The preparation tool 12a is composed of metal, in the present case in particular of steel. Furthermore, the preparation tool 12a in an exemplary manner comprises three cutter elements 30a. The cutter elements 30a are disposed at an angular spacing of 120°. The preparation tool 12a is provided for preparing a preparation product. The preparation tool 12a is provided for a ground-proximate preparation, in particular for cutting and/or mowing a lawned area. Alternatively, however, other preparation units, in particular having other preparation tools, other cutter blades, and/or cutter blades having another number of cutter elements, cutting geometries, and/or composed of other materials, are also conceivable. Also, a preparation unit, in particular a preparation-tool receptacle and/or a preparation tool, could at least in part, preferably at least to a major part, and particularly preferably entirely, be composed of an arbitrary material such as, for example, plastics, a composite material, an alloy, a ceramics material, and/or a metal such as steel, for example.

Furthermore, the ground-preparation chamber 20a defines at least an opening 50a, 52a. In the present case, the ground-preparation chamber 20a defines two openings 50a, 52a. A first opening 50a of the openings 50a, 52a is configured as a preparation-product infeed opening and in relation to a preferred direction of movement 44a of the ground-preparation appliance 24a is disposed ahead of the preparation unit 11a. A second opening 52a of the openings 50a, 52a, is configured as a preparation-product outfeed opening and in relation to the preferred direction of movement 44a of the ground-preparation appliance 24a is disposed behind the preparation unit 11a. The openings 50a, 52a herein are provided for infeeding and outfeeding a preparation product, in the present case of in particular a cut product, in particular grass, to the preparation unit 11a and from the preparation unit 11a.

In order for the preparation unit 11a to be driven and/or operated, the ground-preparation appliance device comprises a drive unit 36a. The drive unit 36a is disposed in the appliance housing 28a. The drive unit 36a comprises a motor, in the present case in particular an electric motor. The drive unit 36a has at least an operational connection to the preparation unit 11a. To this end, the drive unit 36a may comprise further units such as, for example, at least a gearbox. Moreover, the ground-preparation appliance device comprises a running-gear drive 38a. The running-gear drive 38a is provided for driving the running gear 35a in a manner known per se. The running-gear drive 38a in the present case has at least an operational connection to the drive unit 36a. Alternatively, however, it is also conceivable for a running-gear drive to be configured so as to be entirely separate and/or autonomous from a drive unit. For the supply of energy, the ground-preparation appliance device furthermore comprises an energy-storage unit 10a. The energy-storage unit 10a to a major part is disposed within the appliance housing 28a. In the present case, the energy-storage unit 10a is fixedly installed. The energy-storage unit 10a is configured as a rechargeable battery, in particular as a rechargeable lithium-ion battery. The energy-storage unit 10a comprises at least one energy cell 76a, in the present case in particular a rechargeable battery cell, and in particular is configured as at least one energy cell 76a. An optimal operating-temperature range of the energy-storage unit 10a herein lies between 18° C. and 25° C. The energy-storage unit 10a furthermore has at least an operational connection to the drive unit 36a. The energy-storage unit 10a herein is at least provided for supplying energy to the drive unit 36a in at least an operating state. Alternatively, it is conceivable for an energy-storage unit to be configured as a battery and/or as a fuel cell. Moreover, an energy-storage unit could be configured so as to be interchangeable and/or replaceable. Moreover, the ground-preparation appliance device comprises further units for operating the ground-preparation appliance 24a, such as an electronics unit 40a and a controller unit 42a, for example. In the present case, the energy-storage unit 10a is provided for supplying energy to the electronics unit 40a and to the controller unit 42a.

In order to guarantee an operation of the energy-storage unit 10a that is efficient in terms of output and/or free from damage, a temperature of the energy-storage unit 10a should at all times be in the optimal operating-temperature range. In particular in the case of very hot and/or cold environmental temperatures such as in midsummer and/or in indoor ice rinks, for example, a temperature of the energy-storage unit 10a in the case of solutions that are known to date often cannot however be kept in this optimal operating-temperature range, which may lead in particular to cooling intervals and/or heating intervals, in particular in the case of a temperature of the energy-storage unit 10a climbing beyond a critical value of approximately 65° C. and/or dropping below a critical value of approximately 5° C.

For this reason, the ground-preparation appliance device has a temperature-control unit 14a for modifying and/or adapting the temperature of the energy-storage unit 10a. The temperature-control unit 14a is configured so as to be passive. The temperature-control unit 14a to a major part is disposed within the appliance housing 28a. The temperature-control unit 14a in relation to the preferred direction of movement 44a of the ground-preparation appliance 24a is disposed in a forward region of the appliance housing 28a. Moreover, the temperature-control unit 14a is at least in part disposed outside the appliance housing 28a. The temperature-control unit 14a herein has a passage point 66a through the appliance housing 28a. The temperature-control unit 14a is disposed in a vicinity of the preparation unit 11a. In the present case, the temperature-control unit 14a is at least in part disposed in the ground-preparation chamber 20a. The temperature-control unit 14a is furthermore disposed in a vicinity of the first opening 50a. Thus, the temperature-control unit 14a in relation to the preferred direction of movement 44a of the ground-preparation appliance 24a is disposed ahead of the preparation unit 11a. Moreover, the temperature-control unit 14a in the present case is aligned in such a manner that a main direction of extent 68a of the temperature-control unit 14a is aligned so as to be perpendicular to the preferred direction of movement 44a of the ground-preparation appliance 24a. Moreover, the main direction of extent 68a of the temperature-control unit 14a is aligned so as to be horizontal in relation to a supporting ground.

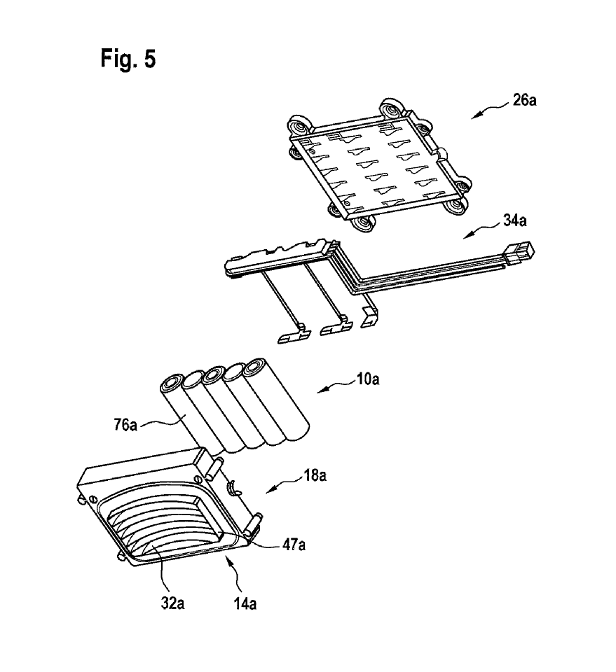

In order for the protection classification of the ground-preparation appliance 24a to be maintained, the ground-preparation appliance device moreover comprises a sealing unit 46a. The sealing unit 46a is designed so as to be elastic. The sealing unit 46a is composed of a rubber material. The sealing unit 46a is disposed on the appliance housing 28a, in particular fastened thereto. In a fitted state, the sealing unit 46a completely encompasses the temperature-control unit 14a. The sealing unit 46a herein bears on a sealing face 47a of the temperature-control unit 14a (cf. also FIG. 5). The sealing unit 46a is provided for closing off the passage point 66a of the temperature-control unit 14a through the appliance housing 28a at least in a substantially fluid-tight manner. In principle, it is also conceivable for a sealing unit of any other material to be used.

Moreover, the temperature-control unit 14a at least in part is disposed in an air flow 16a that is generated by the preparation unit 11a. The temperature-control unit 14a herein has a thermal connection to the air flow 16a. Moreover, the temperature-control unit 14a has a thermal connection to the energy-storage unit 10a. The temperature-control unit 14a in the present case is provided for cooling the energy-storage unit 10a. The temperature-control unit 14a is provided for reducing a temperature of the energy-storage unit 10a in at least an operating state and for keeping said temperature preferably at least below 65° C., advantageously at least below 45° C. The temperature-control unit 14a herein is intended to use, in the at least one operating state, the air flow 16a that is generated by the preparation unit 11a and that emanates from the preparation unit 11a for transmitting heat from the energy-storage unit 10a to an environmental region, in particular of the ground-preparation appliance 24a. The preparation unit 11a herein at least in part acts as a fan and/or a ventilator. Alternatively or additionally, a temperature-control unit could also be provided for heating an energy-storage unit. Also, a preparation unit could have at least an air-guide means, for example an aerodynamic profile, in particular in order to amplify the air flow and/or in order to improve a cooling output. Moreover, a ground-preparation appliance device could also comprise further units such as, for example, a base station, a standalone blower unit, an in particular additional cooling unit, and/or an in particular additional heating unit, which may be provided alternatively or additionally for cooling and/or heating the energy-storage unit. It is also conceivable for an air flow that in particular is generated by a preparation unit and/or that advantageously emanates from the latter to be used for cooling and/or heating other components such as, for example, a drive unit, an electronics unit, and/or a controller unit, and/or for executing more comprehensive tasks such as, for example, for collecting cut product.

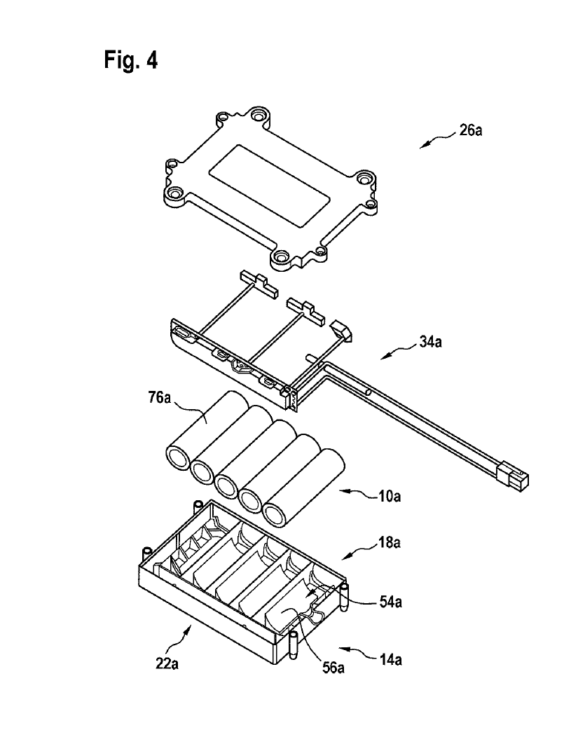

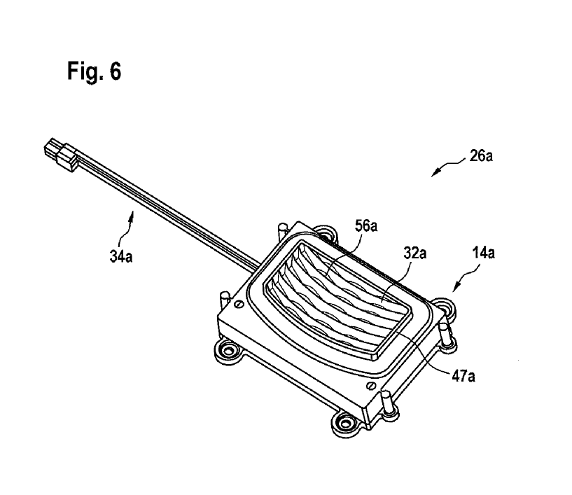

One design embodiment of the temperature-control unit 14a will now be explained in more detail hereunder (cf. also FIGS. 4, 5, and 6). The temperature-control unit 14a has an energy-storage receptacle 18a. The energy-storage receptacle 18a in the present case is composed at least to a major part of plastics. The energy-storage receptacle 18a is configured as a receptacle housing. The energy-storage receptacle 18a is configured in two parts. The energy-storage receptacle 18a is provided for receiving the energy-storage unit 10a. The energy-storage receptacle 18a is provided for mounting the energy-storage unit 10a at least in a substantially fluid-tight, in particular water-tight, manner, on account of which effective discharging of heat is required, in particular. The energy-storage receptacle 18a contacts the energy-storage unit 10a. The energy-storage receptacle 18a and the energy-storage unit 10a herein have a contact face 54a and/or a structure, the latter being adapted to both the former. The energy-storage receptacle 18a has a thermal connection to the energy-storage unit 10a. The energy-storage receptacle 18a is provided for disposing the energy-storage unit 10a in a vicinity of the preparation unit 11a. In the present case, the energy-storage receptacle 18a is moreover provided for disposing the energy-storage unit 10a at least in part in the ground-preparation chamber 20a. Moreover, the energy-storage receptacle 18a is provided for aligning the energy-storage unit 10a in such a manner that a main direction of extent 70a of the energy-storage unit 10a is aligned so as to be perpendicular to the preferred direction of movement 44a of the ground-preparation appliance 24a. Moreover, the main direction of extent 70a of the energy-storage unit 10a is aligned so as to be horizontal in relation to a supporting ground. In the present case, the main direction of extent 70a of the energy-storage unit 10a is parallel with the main direction of extent 68a of the temperature-control unit 14a.

Moreover, the temperature-control unit 14a comprises at least a thermal transmitter 22a. The thermal transmitter 22a has a plurality of rib elements 32a. In the present case, the thermal transmitter 22a at least has seven rib elements 32a. The rib elements 32a are configured as fins. The rib elements 32a are configured so as to be arcuate. In the present case, the rib elements 32a are configured so as to be circular-arcuate, in particular along a main flow direction of the air flow 16a. The thermal transmitter 22a and in particular the rib elements 32a herein are aligned in such a manner that a main direction of extent 72a of the thermal transmitter 22a is aligned so as to be perpendicular to the preferred direction of movement 44a of the ground-preparation appliance 24a. Moreover, the main direction of extent 72a of the thermal transmitter 22a is aligned so as to be horizontal in relation to a supporting ground. In the present case, the main direction of extent 72a of the thermal transmitter 22a is parallel with the main direction of extent 70a of the energy-storage unit 10a. The thermal transmitter 22a moreover is composed of a corrosion-resistant material. Furthermore, the thermal transmitter 22a is composed of an electrically isolating material. The thermal transmitter 22a is composed of a polymer, in the present case in particular of HDPE. Alternatively, it is conceivable for a thermal transmitter at least in part, preferably at least to a major part, and particularly preferably entirely, to be composed of any other material such as, for example, of a composite material, an alloy, a ceramics material, plastics with added fillers, and/or of a metal. The thermal transmitter 22a is furthermore disposed in a vicinity of the preparation unit 11a. Moreover, the thermal transmitter 22a is disposed outside the appliance housing 28a, and in particular in the ground-preparation chamber 20a. The thermal transmitter 22a is disposed in a vicinity of the first opening 50a. The thermal transmitter 22a is moreover disposed in the air flow 16a. Furthermore, the thermal transmitter 22a is coupled to the energy-storage receptacle 18a. The thermal transmitter 22a in the present case is configured integrally with the energy-storage receptacle 18a. Moreover, the thermal transmitter 22a has a thermal connection to the energy-storage unit 10a. In the present case, the thermal transmitter 22a contacts the energy-storage unit 10a at least by means of a contact element 56a. The contact element 56a herein extends from the rib elements 32a to the energy-storage unit 10a. The thermal transmitter 22a herein is provided for a direct heat transmission and/or thermal exchange between the air flow 16a and the energy-storage unit 10a.

Furthermore, the ground-preparation appliance device has an insulating unit 48a. The insulating unit 48a is disposed in the insulating-unit receptacle region. The insulating unit 48a is disposed between the external housing shell 62a and the internal housing shell 64a. The insulating unit 48a is composed of glass wool. The insulating unit 48a is provided for insulating the appliance housing 28a at least in part in relation to an environment and, on account thereof, for at least shielding the temperature-control unit 14a and the energy-storage unit 10a, on account of which additional heating of the energy-storage unit 10a may be reduced, in particular.

Alternatively or additionally, it is conceivable for a further insulating unit to be used for insulating a drive unit. Moreover, an insulating unit could be composed of an arbitrary other material. It is also conceivable for an insulating unit to be fastened to an appliance housing in a materially integral manner or by means of any other fastening method.

Moreover, the energy-storage unit 10a at least together with the thermal transmitter 22a forms an energy-storage module 26a (cf. in particular FIG. 4). In the present case, the energy-storage unit 10a, the temperature-control unit 14a, in particular the thermal transmitter 22a and the energy-storage receptacle 18a, and a connection element 34a, which is provided, in particular, for connecting to the electronics unit 40a, of the ground-preparation appliance device form the energy-storage module 26a.

Alternatively or additionally, it is conceivable for a temperature-control unit to comprise further units such as, for example, at least a fluid duct, at least an air-guide means, and/or at least a Peltier element which advantageously may have a thermal connection to an air flow that in particular is generated by the preparation unit and/or advantageously emanates from the latter, and to an energy-storage unit. An energy-storage receptacle and/or a thermal transmitter could also at least in part be composed of another material such as, for example, a metal, in particular aluminum. Moreover, it is conceivable for an energy-storage receptacle and/or a thermal transmitter, in particular having a plurality of rib elements, to be completely dispensed with.

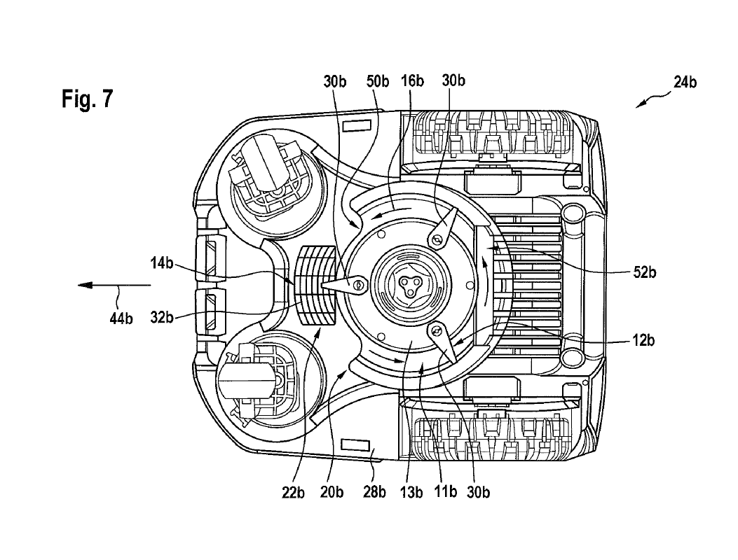

Further exemplary embodiments of the disclosure are shown in FIGS. 7 to 11. The descriptions hereunder and the drawings are substantially limited to the points of differentiation between the exemplary embodiments, wherein in terms of components with identical references, in particular in terms of components having identical reference signs, reference may also be made in principle to the drawings and/or the description of the other exemplary embodiments, in particular those of FIGS. 1 to 6. In order for the exemplary embodiments to be differentiated, the index letter a has been added to the reference signs of the exemplary embodiment in FIGS. 1 to 6. In the exemplary embodiments of FIGS. 7 to 11 the index letter a has been replaced by the index letters b to e.

A further exemplary embodiment of the disclosure is shown in FIG. 7. The index letter b is added to the exemplary embodiment of FIG. 7. The further exemplary embodiment of FIG. 7 at least substantially differs from the previous exemplary embodiment by way of a design embodiment of a temperature-control unit 14b and of a ground-preparation chamber 20b.

In the present case, the ground-preparation chamber 20b is at least in part configured integrally with the temperature-control unit 14b. Herein, a thermal transmitter 22b of the temperature-control unit 14b is in particular configured integrally with the ground-preparation chamber 20b. The ground-preparation chamber 20b herein is composed of a material that has a thermal conductivity of approximately 50 W/mK. In the present case, the ground-preparation chamber 20b is composed of steel. Moreover, it is conceivable for a thermal transmitter 22b having rib elements 32b to be dispensed with in the present case.

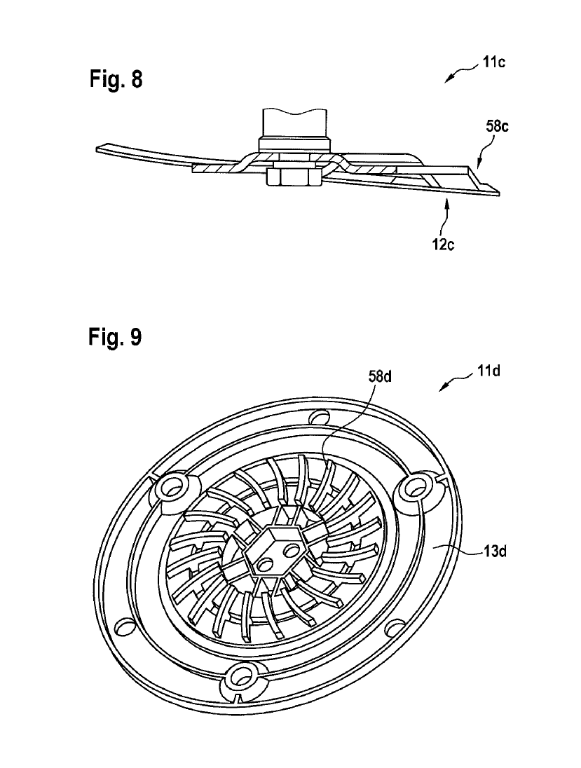

A further exemplary embodiment of the disclosure is shown in FIG. 8. The index letter c has been added to the exemplary embodiment of FIG. 8. The further exemplary embodiment of FIG. 8 at least substantially differs from the previous exemplary embodiments by way of a preparation unit 11c.

In the present case, a temperature-control unit 14c comprises an air-guide means 58c. The air-guide means 58c is configured integrally with the preparation unit 11c, in the present case in particular with a preparation tool 12c of the preparation unit 11c. The air-guide means 58c corresponds to an aerodynamic profile of the preparation unit 11c. The air-guide means 58c is at least provided for guiding in a targeted manner an air flow 16c that is in particular generated by the preparation unit 11c and emanates from the preparation unit 11c. In the present case, the air-guide means 58c is provided for improving a cooling output.

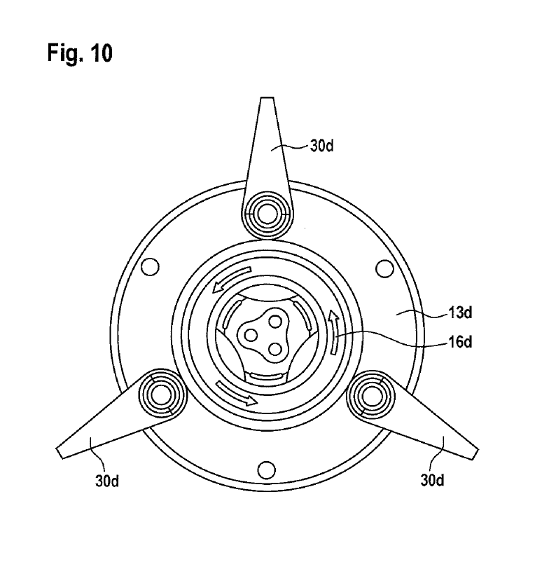

A further exemplary embodiment of the disclosure is shown in FIGS. 9 and 10. The index letter d has been added to the exemplary embodiment of FIGS. 9 and 10. The further exemplary embodiment of FIGS. 9 and 10 at least substantially differs from the previous exemplary embodiments by way of a preparation unit 11d.

In this case, a temperature-control unit 14d comprises a plurality of air-guide means 58d. The air-guide means 58d are configured integrally with the preparation unit 11d, in the present case in particular with a preparation-tool receptacle 13d of the preparation unit 11d. The air-guide means 58d are configured as wing elements. The air-guide means 58c are disposed so as to be concentric in relation to a rotation axis of the preparation unit 11d. The air-guide means 58d herein extend radially outward. The air-guide means 58d are configured so as to be arcuate and are bent in particular in the direction of rotation. The air-guide means 58d is at least provided for guiding in a targeted manner an air flow 16d that is in particular generated by the preparation unit 11d and emanates from the preparation unit 11d. In the present case, the air-guide means 58d is provided for amplifying the air flow 16d.

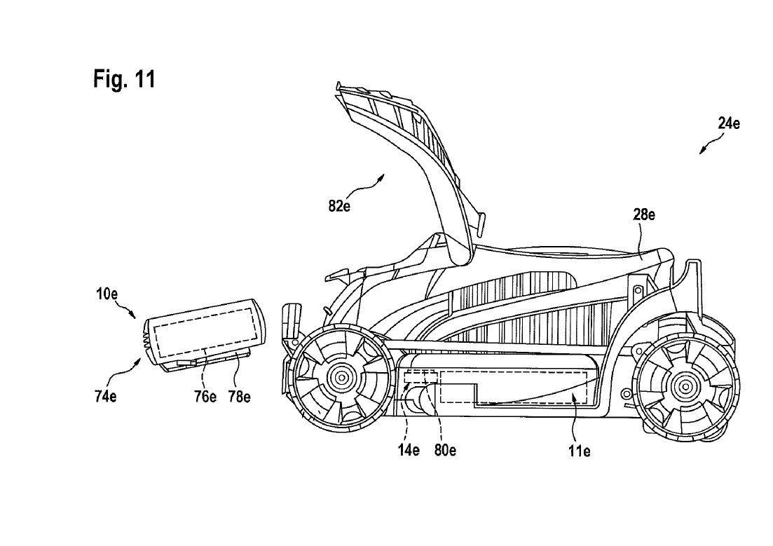

A further exemplary embodiment of the disclosure is shown in FIG. 11. The index letter e has been added to the exemplary embodiment of FIG. 11. The further exemplary embodiment of FIG. 11 at least substantially differs from the previous exemplary embodiments by way of an energy-storage unit 10e.

In the present case, an appliance housing 28e has an opening flap 82e. Moreover, the energy-storage unit 10e, in particular by means of the opening flap 82e, is configured so as to be interchangeable and/or replaceable. The energy-storage unit 10e comprises an energy-storage housing 74e and at least an energy cell 76e. The energy cell 76e is disposed within the energy-storage housing 74e. Moreover, the energy-storage unit 10e has a first interface 78e, in particular for connecting to a temperature-control unit 14e. The temperature-control unit 14e is fixed within the appliance housing 28e. The temperature-control unit 14e has a second interface 80e for integrating the energy-storage unit 10e. The second interface 80e in the present case corresponds to an energy-storage receptacle 18e which is provided in particular for at least in part receiving the energy-storage unit 10e and for at least in part disposing the latter in a vicinity of a preparation unit 11e. The second interface 80e is configured in a manner corresponding to that of the first interface 78e. In the present case, the first interface 78e and the second interface 80e are provided for a form-fitting connection between the energy-storage unit 10e and the temperature-control unit 14e. Alternatively, it is also conceivable that at least an element of a temperature-control unit could be connected to the energy-storage unit and/or be configured integrally with the latter, and that the energy-storage unit is interchangeable and/or replaceable conjointly with the element of the temperature-control unit. In this case, the energy-storage unit and/or the element of the temperature-control unit could comprise a first interface for connecting to a second interface of a further element of the temperature-control unit. It is also conceivable for at least a contacting element such as, for example, a heat-conducting paste, a heat-conducting gel, and/or an elastic element having heat-conducting properties to be used for improving a thermal contact.

What is claimed is:

1. A ground-preparation device, comprising:
an energy storage unit;
a movably drivable preparation unit configured to generate an airflow; and
a temperature control unit configured to use the airflow to transmit heat at least one of to and from the energy storage unit.

2. The ground-preparation device of claim 1, the ground-preparation device configured such that the airflow is at least substantially oriented in a direction from the preparation unit toward the energy storage unit.

3. The ground-preparation device of claim 1, the temperature control unit further configured to cool the energy storage unit.

4. The ground-preparation device of claim 1, further comprising:
an energy storage receptacle configured to receive the energy storage unit so that the energy storage unit is disposed in a vicinity of the preparation unit.

5. The ground-preparation device of claim 1, further comprising:
a ground-preparation chamber, wherein at least one of:
the preparation unit and the temperature control unit are each substantially disposed within the ground-preparation chamber; and
the temperature control unit at least one of directly contacts and directly touches the ground-preparation chamber.

6. The ground-preparation device of claim 5, wherein the energy storage unit is disposed, at least in part, within the ground-preparation chamber.

7. The ground-preparation device of claim 1, further comprising:
a ground preparation chamber that defines an opening configured to enable at least one of infeeding and outfeeding of at least a part of a preparation material to and from the preparation unit, respectively,
wherein the temperature control unit is disposed, at least in part, in a vicinity of the opening.

8. The ground-preparation device of claim 1, further comprising:
a ground-preparation chamber that is integral with the temperature control unit, at least in part.

9. The ground-preparation device of claim 1, wherein the temperature control unit is disposed ahead of the preparation unit along a direction of movement.

10. The ground-preparation device of claim 1, wherein:
the temperature control unit includes an interface configured to couple to the energy storage unit; and
the energy storage unit is configured so as to be at least one of interchangeably and replaceably received by the interface.

11. The ground-preparation device of claim 1, further comprising:
at least one appliance housing, the temperature control unit disposed outside of the housing, at least in part; and
at least one sealing unit configured to close off a passage point through the appliance housing of the temperature control unit in an at least substantially fluid-tight manner.

12. The ground-preparation device of claim 1, further comprising:
at least one external appliance housing; and
an insulating unit configured to at least partially insulate the external appliance housing from an environment.

13. The ground-preparation device of claim 1, wherein the ground-preparation device is disposed in a lawn mower.

14. An energy storage module for a ground-preparation appliance device, comprising:
an energy storage unit; and
at least one thermal transmitter that, in an operating state, is at least partially disposed in an airflow generated by a preparation unit and directed in a flow direction from the preparation unit toward the energy storage unit, and that is configured to exchange heat between the air flow and the energy storage unit.

15. A method of operating a ground-preparation appliance device, comprising:
operating a movably drivable preparation unit to generate at least one air flow; and
transmitting heat at least one of from and to an energy storage unit via the air flow.

16. The method of claim 14, further comprising:
directing the air flow in a flow direction from the preparation unit toward the energy storage unit.
